(19) United States
(12) Patent Application Publication
(10) Pub. No.: US 2008/0306773 A1
(43) Pub. Date: Dec. 11, 2008

(54) SYSTEM AND METHOD FOR OBTAINING MEDICAL RECORDS

(75) Inventors: Ken H. Rosenfeld, Pittsford, NY (US); Michael J. Margiotta, Victor, NY (US)

Correspondence Address: HOLLAND & KNIGHT LLP, 10 ST. JAMES AVENUE, 11th Floor, BOSTON, MA, 02116-3889, US

(73) Assignee: eHealth Global Technologies,, Rochester, NY (US)

(21) Appl. No.: 12/131,504

(22) Filed: Jun. 2, 2008

Related U.S. Application Data
(63) Continuation-in-part of application No. 11/609,034, filed on Dec. 11, 2006.

(51) Int. Cl. G06Q 50/00; G06F 17/30

(52) U.S. Cl. 705/3

(57) ABSTRACT

A method, computer program product, and system for receiving a request, from an individual, for one or more medical records concerning a person/patient. At least a first portion of the one or more medical records is requested from a first medical services provider. The at least a first portion of the one or more medical records is obtained from the first medical services provider. The availability of the at least a first portion of the one or more medical records is enabled to the individual.

### RELATED APPLICATION(S)

This application is a continuation-in-part and claims priority to U.S. application Ser. No. 11/609,034, entitled “SYSTEM AND METHOD FOR MANAGING MEDICAL RECORDS”, filed on 11 Dec. 2006, the entire contents of which are incorporated herein by reference.

### TECHNICAL FIELD

This disclosure relates to medical records and, more particularly, to the management of medical records.

### BACKGROUND

Patients are often treated by a multiplicity of medical professionals. For example, a patient may use a general practitioner for routine medical care. Additionally, the patient may use several specialized practitioners to treat various ailments. Examples of such specialized practitioners may include but are not limited to rheumatologists, cardiologists, and oncologists.

Often, when a patient is referred to a specialized practitioner from a general practitioner, the specialized practitioner may request a copy of the various medical records concerning the patient. For example, if the general practitioner referred the patient to a cardiologist due to the patient failing a stress test, the cardiologist may request a copy of the medical records associated with the stress test so that the patient does not have to undergo duplicative testing procedures.

Typically, the responsibility of obtaining copies of the patient's medical records is often placed on an administrator or assistant within the office of the specialized practitioner. Unfortunately, this task often proves difficult due to the high existing workloads of administrators/assistants and the lack of existing business relationships between the office of the specialized practitioner and the office of the general practitioner.

The responsibility for obtaining copies of the patient's medical records may also fall on the patient. This can cause significant additional stress to the patient, particularly since it is during a time of ill health. Furthermore, patients typically do not have the training to validate that the records they are collecting are the correct ones, and if they show up at the specialized practitioner without their records, or the incorrect ones, they may have to cancel the appointment and reschedule, causing further stress to the patient, and unrecoverable costs to the specialist.

### SUMMARY OF DISCLOSURE

In a first implementation of this disclosure, a method includes receiving a request, from an individual, for one or more medical records concerning a person/patient. At least a first portion of the one or more medical records is requested from a first medical services provider. The at least a first portion of the one or more medical records is obtained from the first medical services provider. The availability of the at least a first portion of the one or more medical records is enabled to the individual.

One or more of the following features may be included. Enabling the availability may include enabling the availability of an electronic copy of the at least a first portion of the one or more medical records to the individual. The electronic copy of the at least a first portion of the one or more medical records may be streamed to the individual.

The individual may be notified of the availability of the at least a first portion of the one or more medical records obtained from the first medical services provider. Notifying the individual may include notifying the individual of the availability of an electronic copy of the at least a first portion of the one or more medical records obtained from the first medical services provider. Notifying the individual may include providing the individual with a link to an electronic copy of the at least a first portion of the one or more medical records obtained from the first medical services provider.

Requesting, from a first medical services provider, at least a first portion of the one or more medical records may include sending an electronic request to the first medical services provider. Requesting, from a first medical services provider, at least a first portion of the one or more medical records may include sending a paper-based request to the first medical services provider. The one or more medical records may be chosen from the group consisting of: one or more text-based medical records; one or more image-based medical records; and one or more computer file-based medical records.

At least a second portion of the one or more medical records may be requested from a second medical services provider. The at least a second portion of the one or more medical records may be obtained from the second medical services provider. The availability of the at least a second portion of the one or more medical records may be enabled to the individual.

In another implementation of this disclosure, a computer program product resides on a computer readable medium and has a plurality of instructions stored on it. When executed by a processor, the instructions cause the processor to perform operations including receiving a request, from an individual, for one or more medical records concerning a person/patient. At least a first portion of the one or more medical records is requested from a first medical services provider. The at least a first portion of the one or more medical records is obtained from the first medical services provider. The availability of the at least a first portion of the one or more medical records is enabled to the individual.

One or more of the following features may be included. Enabling the availability may include enabling the availability of an electronic copy of the at least a first portion of the one or more medical records to the individual. The electronic copy of the at least a first portion of the one or more medical records may be streamed to the individual.

The individual may be notified of the availability of the at least a first portion of the one or more medical records obtained from the first medical services provider. Notifying the individual may include notifying the individual of the availability of an electronic copy of the at least a first portion of the one or more medical records obtained from the first medical services provider. Notifying the individual may include providing the individual with a link to an electronic copy of the at least a first portion of the one or more medical records obtained from the first medical services provider.

Requesting, from a first medical services provider, at least a first portion of the one or more medical records may include sending an electronic request to the first medical services provider. Requesting, from a first medical services provider, at least a first portion of the one or more medical records may include sending a paper-based request to the first medical services provider. The one or more medical records may be chosen from the group consisting of: one or more text-based medical records; one or more image-based medical records; and one or more computer file-based medical records.

At least a second portion of the one or more medical records may be requested from a second medical services provider. The at least a second portion of the one or more medical records may be obtained from the second medical services provider. The availability of the at least a second portion of the one or more medical records may be enabled to the individual.

In another implementation of this disclosure, a system is configured to perform operations including receiving a request, from an individual, for one or more medical records concerning a person/patient. At least a first portion of the one or more medical records is requested from a first medical services provider. The at least a first portion of the one or more medical records is obtained from the first medical services provider. The availability of the at least a first portion of the one or more medical records is enabled to the individual.

One or more of the following features may be included. Enabling the availability may include enabling the availability of an electronic copy of the at least a first portion of the one or more medical records to the individual. The electronic copy of the at least a first portion of the one or more medical records may be streamed to the individual.

The individual may be notified of the availability of the at least a first portion of the one or more medical records obtained from the first medical services provider. Notifying the individual may include notifying the individual of the availability of an electronic copy of the at least a first portion of the one or more medical records obtained from the first medical services provider. Notifying the individual may include providing the individual with a link to an electronic copy of the at least a first portion of the one or more medical records obtained from the first medical services provider.

Requesting, from a first medical services provider, at least a first portion of the one or more medical records may include sending an electronic request to the first medical services provider. Requesting, from a first medical services provider, at least a first portion of the one or more medical records may include sending a paper-based request to the first medical services provider. The one or more medical records may be chosen from the group consisting of: one or more text-based medical records; one or more image-based medical records; and one or more computer file-based medical records.

At least a second portion of the one or more medical records may be requested from a second medical services provider. The at least a second portion of the one or more medical records may be obtained from the second medical services provider. The availability of the at least a second portion of the one or more medical records may be enabled to the individual.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a record management process executed in whole or in part by a computer coupled to a distributed computing network;

FIG. 2 is a flowchart of the record management process of FIG. 1;

FIG. 3 is a diagrammatic view of an electronic request template as rendered by the record management process of FIG. 1;

FIG. 4 is a diagrammatic view a cellular telephone configured to access the record management process of FIG. 1; and

FIG. 5 is a diagrammatic view of a personal digital assistant configured to access the record management process of FIG. 1.

### DETAILED DESCRIPTION OF THE PREFERRED EMBODIMENTS

### System Overview:

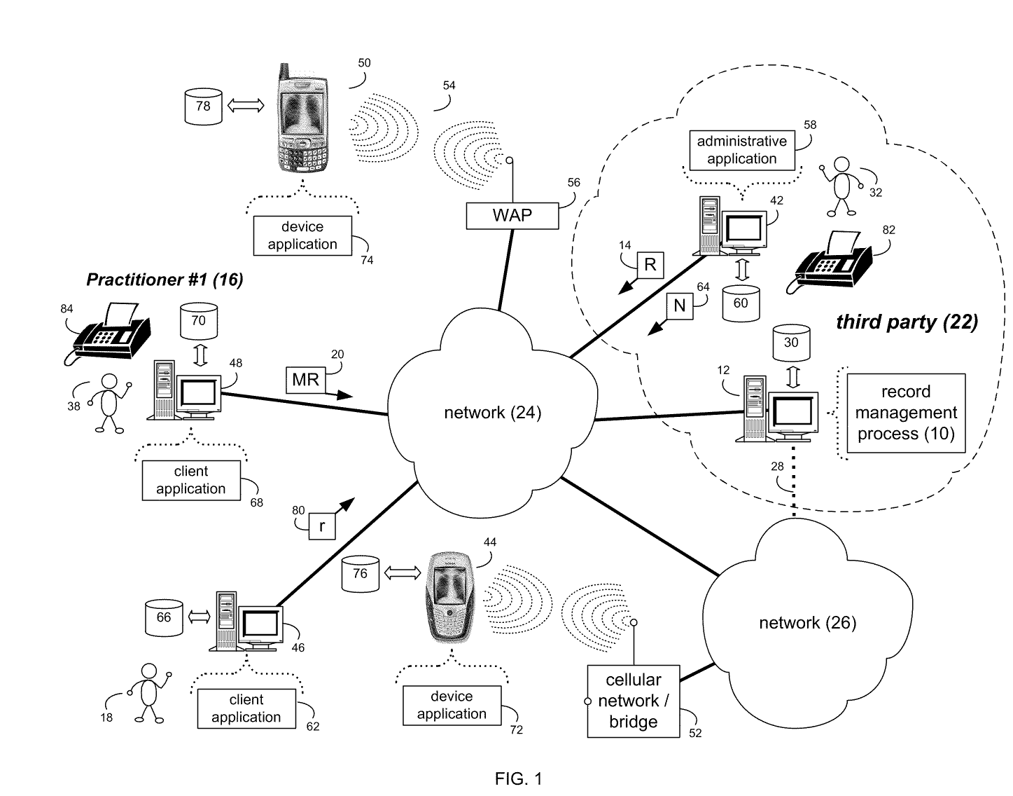

Referring to FIG. 1, there is shown a record management process 10, which may be a server-based application resident on (in whole or in part) and executed by (in whole or in part) computer 12 (e.g., a single server computer, a plurality of server computers, or a general purpose computer, for example). As will be discussed below in greater detail, record management process 10 may allow for a request 14 to be made of a first practitioner 16, on behalf of an individual 18, requesting that the first practitioner 16 provide a copy of the individual's medical records 20 to a third party 22, so that the third party 22 can make the copy of medical records 20 available to individual 18.

Computer 12 may be coupled to network 24 (e.g., the Internet). Computer 12 may be, for example, a web server running a network operating system, examples of which may include but are not limited to Microsoft Windows XP Server™, or Redhat Linux™.

Computer 12 may also execute a web server application, examples of which may include but are not limited to Microsoft IIS™, or Apache Webserver™, that allows for HTTP (i.e., HyperText Transfer Protocol) access to computer 12 via network 24. Network 24 may be coupled to one or more secondary networks (e.g., network 26), such as: a local area network; a wide area network; or an intranet, for example. Additionally/alternatively, computer 12 may be coupled to network 24 through secondary network 26, as illustrated with phantom link line 28.

The instruction sets and subroutines of record management process 10, which may be stored on a storage device 30 coupled to computer 12, may be executed by one or more processors (not shown) and one or more memory architectures (not shown) incorporated into computer 12. Storage device 30 may include but is not limited to a hard disk drive, a tape drive, an optical drive, a RAID array, a random access memory (RAM), or a read-only memory (ROM).

Users 32, 38 may access record management process 10 (directly through network 24 or through secondary network 26) using various client electronic devices, examples of which may include but are not limited to: administrative computer 42, data-enabled cellular telephone 44, client computer 46, client computer 48, personal digital assistant 50, laptop computers (not shown), and dedicated network appliances (not shown), for example.

The various client electronic devices may be directly or indirectly coupled to network 24 (or network 26). For example, administrative computer 44, and client computers 46, 48 are shown directly coupled to network 24 via hardwired network connections. Additionally, cellular telephone 44 is shown wirelessly coupled to cellular network/bridge 52, which is shown directly coupled to network 26. Further, personal digital assistant 50 is shown wirelessly coupled to network 24 via a wireless communication channel 54 established between personal digital assistant 50 and wireless access point (i.e., WAP) 56, which is shown directly coupled to network 24.

WAP 56 may be, for example, an IEEE 802.11a, 802.11b, 802.11g, Wi-Fi, and/or Bluetooth device that is capable of establishing secure communication channel 54 between personal digital assistant 50 and WAP 56.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Client Software:

Administrative computer 42 may execute an administrative application 58, examples of which may include but are not limited to a web browser application (e.g., Microsoft Internet Explorer™ and Netscape Navigator™), an email client (Microsoft Outlook™, Lotus Notes™, and Novell Groupwise™) or a specialized interface that allows e.g., individual 18 to access and configure record management process 10 and generate and provide request 14 to first practitioner 16 via network 24 (and/or network 26). Administrative computer 42 may execute an operating system, examples of which may include but are not limited to Microsoft Windows XP™ or Redhat Linux™.

The instruction sets and subroutines of administrative application 58, which may be stored on a storage device 60 coupled to administrative computer 42, may be executed by one or more processors (not shown) and one or more memory architectures (not shown) incorporated into administrative computer 42. Storage device 60 may include but is not limited to a hard disk drive, a tape drive, an optical drive, a RAID array, a random access memory (RAM), or a read-only memory (ROM).

Client computer 46 may execute a client application 62, examples of which may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™) or a specialized interface that allows e.g., individual 18 to access record management process 10, receive notification 64 (to be discussed below in greater detail) and view medical records 20 stored on e.g., computer 12 (via network 24 and/or network 26). Client computer 46 may execute an operating system, examples of which may include but are not limited to Microsoft Windows XP™ or Redhat Linux™.

The instruction sets and subroutines of client application 62, which may be stored on a storage device 66 coupled to client computer 46, may be executed by one or more processors (not shown) and one or more memory architectures (not shown) incorporated into client computer 46. Storage device 66 may include but is not limited to a hard disk drive, a tape drive, an optical drive, a RAID array, a random access memory (RAM), or a read-only memory (ROM).

Client computer 48 may execute a client application 68, examples of which may include but are not limited to a web browser application (e.g., Microsoft Internet Explorer™ and Netscape Navigator™), an email client (Microsoft Outlook™, Lotus Notes™, and Novell Groupwise™), or a specialized interface that allows e.g., user 38 to access record management process 10, receive request 14 from e.g., administrative computer 42, and provide medical records 20 to computer 12 (via network 24 and/or network 26). Client computer 48 may execute an operating system, examples of which may include but are not limited to Microsoft Windows XP™ or Redhat Linux™.

The instruction sets and subroutines of client application 68, which may be stored on a storage device 70 coupled to client computer 48, may be executed by one or more processors (not shown) and one or more memory architectures (not shown) incorporated into client computer 48. Storage device 70 may include but is not limited to a hard disk drive, a tape drive, an optical drive, a RAID array, a random access memory (RAM), or a read-only memory (ROM).

Cellular telephone 44 and/or personal digital assistant 50 may execute a client application 72, 74 (respectively), examples of which may include but are not limited to a web browser application (e.g., Microsoft Internet Explorer™ and Netscape Navigator™), an email client (Microsoft Outlook™, Lotus Notes™, and Novell Groupwise™), a data viewing application (e.g., Citrix Access Gateway™), or a specialized interface that allows e.g., users of cellular telephone 44 and/or personal digital assistant 50 (e.g., individual 18 who requested medical records 20) to access record management process 10, receive notification 64 (to be discussed below in greater detail) and view medical records 20 stored on e.g., computer 12 (via network 24 and/or network 26). Cellular telephone 44 and/or personal digital assistant 50 may execute an operating system, examples of which may include but are not limited to Microsoft Windows Mobile™, Redhat Linux™, Palm OS™, or a device-specific (i.e., custom) operating system.

The instruction sets and subroutines of client application 72, 74, which may be stored on a storage device 76, 78 (respectively) coupled to cellular telephone 44 and/or personal digital assistant 50 (respectively), may be executed by one or more processors (not shown) and one or more memory architectures (not shown) incorporated into cellular telephone 44 and/or personal digital assistant 50. Storage device 76, 78 may include but are not limited to a hard disk drive, a tape drive, an optical drive, a RAID array, a random access memory (RAM), a read-only memory (ROM) a Compact Flash (CF) card, a Secure Digital (SD) card, a SmartMedia card, a Memory Stick, and a MultiMedia card, for example.

### Record Management Process:

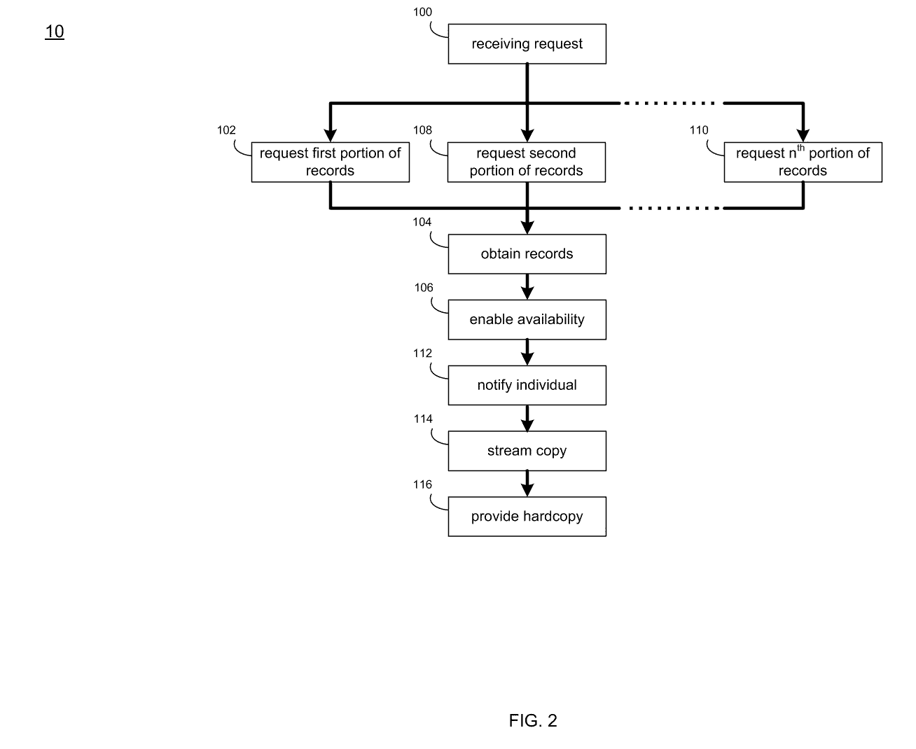

Referring also to FIG. 2, record management process 10 may receive 100 a request 80, from individual 18, for one or more medical records 20 in the possession of first medical services provider 16. Individual 18 may be representative of a person/patient who wishes to obtain copies of their medical records from the various medical services providers that have provided service to person/patient. Alternatively, individual 18 may be representative of an agent that is working on behalf of a person/patient that wishes to obtain copies of their medical records from the various medical services providers that have provided service to person/patient. Further, individual 18 may be the person/patient or may be a care provider of the person/patient.

The request 80 received 100 by record management process 10 may be in the form of an electronic request (e.g., an email, or an online request), a telephone request (e.g., a voice call received by individual 18 or a data call received by an automated data entry system coupled to/included within record management process 10), or a paper request (e.g., a facsimile-based request or a request received via courier/mail).

Once request 80 is received 100, record management process 10 may prepare, on behalf of individual 18, request 14 for one or more medical records 20 from first medical services provider 16. Request 14 may be provided 102 to first medical services provider 16. Medical records 20 may be obtained 104 from first medical services provider 16, which may be made available 106 to individual 18.

Further, additional requests (not shown) may be made of additional medical services providers (not shown). For example, assume that three medical services providers were providing medical services to individual 18. Accordingly, upon receiving 100 request 80, third party 22 may: provide 102 a first request (e.g., request 14) to first medical services provider 16 for a first portion of medical records 20 of individual 18; provide 108 a second request (not shown) to a second medical services provider (not shown) for a second portion of medical records 20 of individual 18; and provide 110 a third request (not shown) to a third medical services provider (not shown) for a third portion of medical records 20 of individual 18. Once these various medical record portions are obtained 108 by third party 22, the portions may be combined to form medical records 20, which may be made available 108 to individual 18.

For illustrative purposes, assume that individual 18 is a patient that is being treated by two separate medical services providers, namely: first practitioner 16 who is a general purpose medical practitioner treating individual 18 for adult-onset diabetes; and a second practitioner (not shown) who is an oncologist treating individual 18 for prostate cancer. During the course of treatment, first practitioner 16 may generate various medical records, such as text-based medical records, image-based medical records, and/or computer file-based medical records, examples of which may include but are not limited to medical charts, X-rays, CT scans, contact information, familial information, insurance information, ailment and treatment information, genealogy/family history information, three-dimensional rendered images assembled from individual CT scan images, and EEG/EKG waveforms, for example). Further, assume that upon detecting an elevated PSA (i.e., prostate specific antigen) score, individual 18 was referred to the second practitioner (i.e., the oncologist) for further testing and subsequent treatment of prostate cancer.

Assume that individual 18 may have been previously treated by various other medical services providers (not shown) for various other ailments. Further, assume that individual 18 wishes to have a complete set of their medical records gathered and made available for future review/use by individual 18, first practitioner 16, the second practitioner (i.e., the oncologist; not shown), and any other past or future medical services providers (as selected by individual 18). Accordingly, individual 18 may provide request 80 (e.g., an online request, an email request, a facsimile request, or a telephone request) to third party 22 that requests that third party 22 obtain and consolidate some or all of the medical records of individual 18 to generate a consolidated medical record history for individual 18. An example of third party 22 is eHealth Global Technologies, Inc. (http://www.ehealthglobaltech.com) of Rochester, N.Y.

When record management process 10 receives 100 request 80 from individual 18, record management process 100 may require individual 18 to authenticate their identity and/or be an established customer of third party 22. For example, individual 18 may be required to provide third party 22 with one or more unique identifiers assigned to individual 18, examples of which may include but are not limited an account number, a customer number, a password, and a PIN (i.e., personal identification number) code, for example.

For example, upon submitting an electronic request 80 to record management process 10, individual 18 may be required to enter a confidential customer number. Additionally, when submitting a telephone request 80 to record management process 10, individual 18 may be required to enter a PIN code. Alternatively, when submitting a paper request 80 to record management process 10, individual 18 may be required to include a confidential username and/or password on the submitted paperwork.

Additionally, when contacting third party 22, individual 18 may provide sufficient information to identify the specific medical records desired. For example, individual 18 may define the specific medical records desired from first practitioner 16 and the second practitioner (i.e., the oncologist; not shown). Continuing with the above stated example, individual 18 may request from first practitioner 16 and the second practitioner (not shown) any and all medical records rating to individual 18.

Continuing with the above-stated example, once request 80 (e.g., the online request, the telephone request, the email request and/or the facsimile request, for example) is received from individual 18, third party 22 may prepare request 14 for submission to first practitioner 16 and/or the second practitioner (i.e., the oncologist; not shown). The format of request 14 may vary depending on the preferences/needs of first practitioner 16 and/or the second practitioner (i.e., the oncologist; not shown).

Once request 80 is received 100 by third-party 22, record management process 10 may allow the requestor (e.g., individual 18) to determine the status of their request (e.g., request 80) by e.g., accessing a web-based status portal (not shown) that would allow user 18 to enter information that definitively identifies request 80. Once such information is entered, record management process 10 may provide e.g., individual 18 with the status of their request, examples of which may include but are not limited to: received; received and assigned; currently being processed, and completed.

Examples of request 14 may include but are not limited to an electronic request (e.g., an email/online request), a paper-based request (e.g., a facsimile/mailed hardcopy), and a voice-based request (e.g., a voice call/data call). While the following discussion is directed to third party 22 communicating with first practitioner 16, this is for illustrative purposes only and is not intended to be a limitation of this disclosure, as other configurations are possible. For example and as discussed above, individual 18 may be utilizing the services of other medical practitioners (e.g., the second practitioner, not shown) in addition to first practitioner 16.

If request 14 is an electronic request, request 14 may be prepared by individual 18 via administrative application 58. As discussed above, examples of administrative application 58 may include but are not limited to a web browser application (e.g., Microsoft Internet Explorer™ and Netscape Navigator™), an email client (Microsoft Outlook™, Lotus Notes™, and Novell Groupwise™) or a specialized interface.

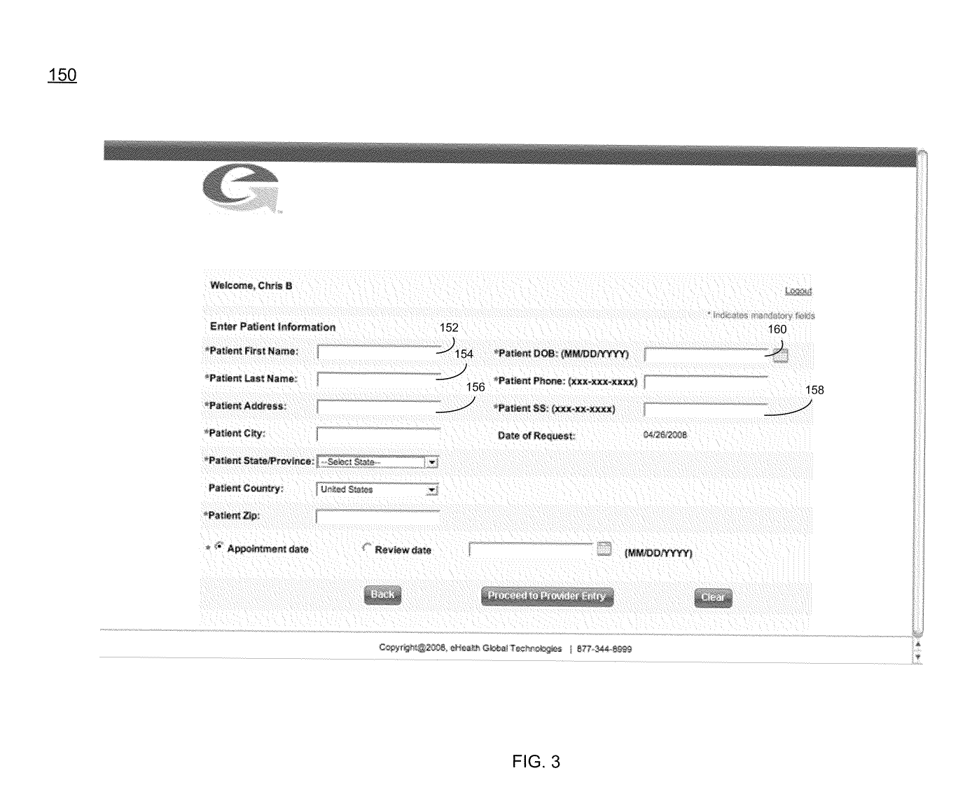

Referring also to FIG. 3, when preparing request 14, an electronic request template 150 (that is populatable by administrative application 58) may be used to define the data fields required for a complete request. For example, electronic request template 150 may include patient first name field 152, patient last name field 154, patient address field 156, patient social security number field 158, and patient birth date field 160, for example

If request 14 is a paper-based request, request 14 may be mailed to first practitioner 16 via e.g., the U.S. Postal Service, an overnight courier, or a messenger service. Alternatively, request 14 may be transmitted from e.g., facsimile machine 82 accessible by third party 22 to facsimile machine 84 accessible by first practitioner 16. When preparing 100 request 14, a paper request template (not shown) may be used to define the data fields required for a complete request. For example, the paper request template may include a patient name field, a patient address field, the patient social security number field, a patient birth date field, and a medical records requested field, for example.

While a paper-based request is described above as utilizing a paper request template (not shown) and a pair of facsimile machines 82, 84, other configurations are possible and are considered to be within the scope of this disclosure. For example, one or both of facsimile machines 82, 84 may be coupled to one or more of computers 42, 48 (respectively). Another example is that person 18 may use computer 46 to populate a web-based request form, which may then be propagated over e.g., network 24 to user 32 through computer 42. Accordingly, facsimile requests may be electronic requests that are prepared 100 using computers 42, 48 and transmitted via analog and/or digital telephone lines (not shown).

Alternatively, individual 18 may contact user 38 via a pair of telephones (not shown) accessible by individual 18/users 38 and make request 14 verbally. When making a verbal request, the information required to properly identify the requested medical records may be provided verbally (e.g., from individual 18 to user 38) or may be provided from individual 18 to an automated data entry system coupled to/included within record management process 10.

Once prepared, request 14 may be provided 102 to first practitioner 16 and/or the second practitioner (i.e., the oncologist; not shown). If an electronic request, request 14 may be provided 102 to e.g., first practitioner 16 when transmitted to e.g., computer 48. If a paper-based request, request 14 may be provided 102 to e.g., first practitioner 16 when e.g., the facsimile is transmitted from facsimile machine 82 to facsimile machine 84. If request 14 is a verbal request, request 14 may be provided to e.g., first practitioner 16 when communication is established between e.g., individual 18 and user 38.

Once request 14 is received by first practitioner 16, first practitioner 16 may begin the process of gathering the medical records requested by individual 18 through third party 22. For example and as discussed above, the medical records requested may include text-based medical records, image-based medical records, and/or computer file-based medical records. Accordingly, each of these various types of records may be gathered by first practitioner 16 and prepared for transmittal to third party 22. The manner in which the requested medical records are prepared for transmittal may vary depending on the format in which the records are provided to third party 22. For example, if hard copies of the requested medical records are to be provided to third party 22, the process of preparing the medical records for transmittal may require that first practitioner 16 generate copies for transmittal to third party 22. For example, film-based copies of X-rays may be prepared, photocopies of medical charts may be prepared, and softcopies of computer files (e.g., three-dimensional rendered images assembled from individual CT scan images, and EEG/EKG waveforms) may be prepared. Once these copies are prepared, the requested medical records 20 (or a portion thereof) may be shipped (via e.g., first class mail or overnight courier) to third party 22 for processing. Alternatively, physical copies of certain medical records may be transmitted (via facsimile) to third party 22. Alternatively/additionally, first practitioner 16 may provide soft copies of the requested medical records to third party 22. For example, image files (e.g., DICOM files, XDS files, PDF files, JPEG files, GIF files, TIF files, EPS files, XML files, CDA files, HL7 messages) of e.g., X-rays and medical charts may be prepared and soft copies of computer-based files may be generated. Once prepared, the requested medical records 20 may be transmitted electronically (via e.g., an email attachment) to third party 22.

Once third party 22 obtains 104 the requested medical records 20 from first practitioner 16, third party 22 may process requested medical records 20 to enable availability 108 of medical records 20 to individual 18. For example, if the requested medical records obtained 104 are paper-based medical records, third party 22 may process requested medical records 20 to enable 108 online availability of requested medical records 20. Therefore, paper-based medical records may be scanned and converted into one or more computer files, examples of which may include but are not limited to DICOM files, XDS files, PDF files, JPEG files, GIF files, TIF files, EPS files, XML files, CDA files, and HL7 messages. If softcopies of the requested medical records 20 are received by third party 22, the files may be processed to convert them into an acceptable format. For example, an EPS format file may be converted into a PDF format file.

Once the requested medical records 20 (or a portion thereof) obtained 104 from first practitioner 16 are in an acceptable format, the requested medical records 20 may be uploaded to e.g., computer 12 and saved in an area accessible by individual 18. For example, third party 22 may post medical records 20 within a secure area of computer 12 so that medical records 20 may be accessed by individual 18. Additionally/alternatively, other portions of medical records 20 may be obtained from other medical services providers (e.g., the second practitioner, not shown), and may be uploaded to e.g., computer 12 and saved in an area accessible by individual 18.

Third party 22 may notify 112 individual 18 of the availability 108 of medical records 20. As discussed above, medical records 20 may be obtained 104 from a single medical services provider (e.g., first practitioner 16) or may be a compilation of various portions of medical records obtained from a plurality of medical services providers (e.g., first practitioner 16 and the second practitioner, not shown).

Notification 64 may be generated and provided to individual 18 by e.g., computer 12 or computer 42. For example, once the requested medical records 20 are received and posted by third party 22, notification 64 may be automatically generated and provided to individual 18. Examples of notification 64 may include, but are not limited to, an email, a facsimile transmission, a text message, and a telephone call.

When notifying individual 18 of the availability of requested medical records 20, notification 64 may define the manner in which the requested medical records may be obtained by individual 18 (and any required passwords). For example, if all requested medical records 20 for individual 18 are placed in a secure remotely-accessible common directory in computer 12, notification 64 may simply instruct individual 18 to check their secure directory for requested medical records 20. Alternatively, if the requested medical records 20 are placed in a unique directory, notification 64 may define the path (e.g., a uniform resource locator) to the unique directory and may provide any required passwords needed to access medical records 20. Alternatively and to enhance security, the required password may be provided in a separate notification or (alternatively) by telephone/first class mail.

As discussed above, computer 12 may execute a web server application that allows for HTTP access to computer 12 via network 24. Accordingly, computer 12 may serve a web-based portal (not shown) for individual 18. Therefore, notification 64 may notify individual 18 that requested medical records 20 are now available on e.g., computer 12. When accessing the web-based portal (not shown), individual 18 may be presented with a plurality of links that point to the medical records available for individual 18. For example, the web-based portal (not shown) may include a link that allows individual 18 to access medical records 20 via e.g., computer 12.

Once notified 112, the manner in which individual 18 obtains the requested medical records 20 may vary depending on the preferences of third party 22 and/or individual 18. For example, a copy of the requested medical records 20 may be downloadable from computer 12 to e.g., computer 46.

Alternatively, downloading may be prohibited and requested medical records 20 may only be streamed 114 from computer 12 to e.g., computer 46. Typically, when requested medical records 20 are streamed 114 from e.g., computer 12 to computer 46, a copy of requested medical records 20 may not be permanently retained on computer 46. Examples of client application 62 that allow for such data streaming 114 may include, but are not limited to: Citrix Access Gateway™ available from Citrix Systems of Fort Lauderdale, Fla.; and EasyViz™ available from Medical Insight A/S of Valby, Denmark.

Additionally, a hardcopy of the requested medical records 20 may be provided 116 to individual 18. For example, a hardcopy of the requested medical records may be provided to individual 18 via: facsimile transmission (e.g., to a facsimile machine accessible by individual 18); via courier service (e.g., overnight courier or messenger service) to the physical address of individual 18; and via mail service to the physical address of individual 18.

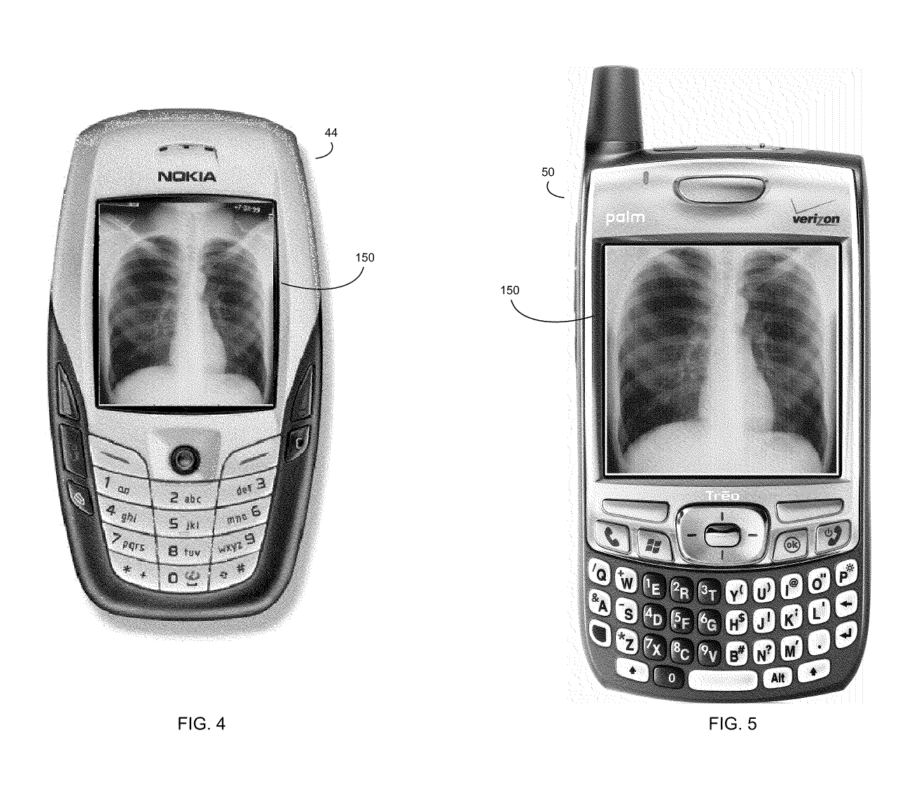

In addition to requested medical records 20 being accessible via e.g., computer 46, requested medical records 20 may be available via one or more mobile devices, examples of which may include but are not limited to cellular telephone 44 and personal digital assistant 50. As discussed above, cellular telephone 44 and personal digital assistant 50 may execute client applications 72, 74 (respectively) to facilitate access to record management process 10, receive notification 64 and view medical records 20 stored on e.g., computer 12. Accordingly, individual 18 may use cellular telephone 44 to access e.g., image 150 of an X-ray included within requested medical records 20 (as shown in FIG. 4) and/or individual 18 may use personal digital assistant 50 to access image 150 of an X-ray included within requested medical records 20 (as shown in FIG. 5).

A number of implementations have been described. Nevertheless, it will be understood that various modifications may be made. Accordingly, other implementations are within the scope of the following claims.

What is claimed is:

1. A method comprising:
receiving a request, from an individual, for one or more medical records concerning a person/patient;
requesting, from a first medical services provider, at least a first portion of the one or more medical records;
obtaining the at least a first portion of the one or more medical records from the first medical services provider; and
enabling the availability of the at least a first portion of the one or more medical records to the individual.

2. The method of claim 1 wherein enabling the availability includes:
enabling the availability of an electronic copy of the at least a first portion of the one or more medical records to the individual.

3. The method of claim 2 further comprising:
streaming the electronic copy of the at least a first portion of the one or more medical records to the individual.

4. The method of claim 1 further comprising:
notifying the individual of the availability of the at least a first portion of the one or more medical records obtained from the first medical services provider.

5. The method of claim 4 wherein notifying the individual includes:
notifying the individual of the availability of an electronic copy of the at least a first portion of the one or more medical records obtained from the first medical services provider.

6. The method of claim 4 wherein notifying the individual includes:
providing the individual with a link to an electronic copy of the at least a first portion of the one or more medical records obtained from the first medical services provider.

7. The method of claim 1 wherein requesting, from a first medical services provider, at least a first portion of the one or more medical records includes:
sending an electronic request to the first medical services provider.

8. The method of claim 1 wherein requesting, from a first medical services provider, at least a first portion of the one or more medical records includes:
sending a paper-based request to the first medical services provider.

9. The method of claim 1 wherein the one or more medical records are chosen from the group consisting of: one or more text-based medical records; one or more image-based medical records; and one or more computer file-based medical records.

10. The method of claim 1 further comprising:
requesting, from a second medical services provider, at least a second portion of the one or more medical records;
obtaining the at least a second portion of the one or more medical records from the second medical services provider; and
enabling the availability of the at least a second portion of the one or more medical records to the individual.

11. A computer program product residing on a computer readable medium having a plurality of instructions stored thereon that, when executed by a processor, cause the processor to perform operations comprising:
receiving a request, from an individual, for one or more medical records concerning a person/patient;
requesting, from a first medical services provider, at least a first portion of the one or more medical records;
obtaining the at least a first portion of the one or more medical records from the first medical services provider; and
enabling the availability of the at least a first portion of the one or more medical records to the individual.

12. The computer program product of claim 11 wherein the instructions for enabling the availability include instructions for:
enabling the availability of an electronic copy of the at least a first portion of the one or more medical records to the individual.

13. The computer program product of claim 12 further comprising instructions for:
streaming the electronic copy of the at least a first portion of the one or more medical records to the individual.

14. The computer program product of claim 11 further comprising instructions for:
notifying the individual of the availability of the at least a first portion of the one or more medical records obtained from the first medical services provider.

15. The computer program product of claim 14 wherein the instructions for notifying the individual include instructions for:
notifying the individual of the availability of an electronic copy of the at least a first portion of the one or more medical records obtained from the first medical services provider.

16. The computer program product of claim 14 wherein the instructions for notifying the individual include instructions for:
providing the individual with a link to an electronic copy of the at least a first portion of the one or more medical records obtained from the first medical services provider.

17. The computer program product of claim 11 wherein the instructions for requesting, from a first medical services provider, at least a first portion of the one or more medical records include instructions for:
sending an electronic request to the first medical services provider.

18. The computer program product of claim 11 wherein the instructions for requesting, from a first medical services provider, at least a first portion of the one or more medical records include instructions for:
sending a paper-based request to the first medical services provider.

19. The computer program product of claim 11 wherein the one or more medical records are chosen from the group consisting of: one or more text-based medical records; one or more image-based medical records; and one or more computer file-based medical records.

20. The computer program product of claim 11 further comprising instructions for:
requesting, from a second medical services provider, at least a second portion of the one or more medical records;
obtaining the at least a second portion of the one or more medical records from the second medical services provider; and
enabling the availability of the at least a second portion of the one or more medical records to the individual.

21. A system configured to perform operations comprising:
receiving a request, from an individual, for one or more medical records concerning a person/patient;
requesting, from a first medical services provider, at least a first portion of the one or more medical records;
obtaining the at least a first portion of the one or more medical records from the first medical services provider; and
enabling the availability of the at least a first portion of the one or more medical records to the individual.

22. The system of claim 21 wherein enabling the availability includes:
enabling the availability of an electronic copy of the at least a first portion of the one or more medical records to the individual.

23. The system of claim 22, wherein the system is further configured to perform operations comprising:
streaming the electronic copy of the at least a first portion of the one or more medical records to the individual.

24. The system of claim 21, wherein the system is further configured to perform operations comprising:
notifying the individual of the availability of the at least a first portion of the one or more medical records obtained from the first medical services provider.

25. The system of claim 24 wherein notifying the individual includes:
notifying the individual of the availability of an electronic copy of the at least a first portion of the one or more medical records obtained from the first medical services provider.

26. The system of claim 24 wherein notifying the individual includes:
providing the individual with a link to an electronic copy of the at least a first portion of the one or more medical records obtained from the first medical services provider.

27. The system of claim 21 wherein requesting, from a first medical services provider, at least a first portion of the one or more medical records includes:
sending an electronic request to the first medical services provider.

28. The system of claim 21 wherein requesting, from a first medical services provider, at least a first portion of the one or more medical records includes:
sending a paper-based request to the first medical services provider.

29. The system of claim 21 wherein the one or more medical records are chosen from the group consisting of: one or more text-based medical records; one or more image-based medical records; and one or more computer file-based medical records.

30. The system of claim 21, wherein the system is further configured to perform operations comprising:
requesting, from a second medical services provider, at least a second portion of the one or more medical records;
obtaining the at least a second portion of the one or more medical records from the second medical services provider; and
enabling the availability of the at least a second portion of the one or more medical records to the individual.
